(19) United States
(12) Patent Application Publication
(10) Pub. No.: US 2025/0108994 A1
(43) Pub. Date: Apr. 3, 2025

(54) PRINTING APPARATUS, CONTROL METHOD FOR PRINTING APPARATUS, AND NON-TRANSITORY COMPUTER-READABLE STORAGE MEDIUM

(71) Applicant: CANON KABUSHIKI KAISHA, Tokyo (JP)

(72) Inventor: RYO SOGABE, Tokyo (JP)

(21) Appl. No.: 18/899,729

(22) Filed: Sep. 27, 2024

(30) Foreign Application Priority Data
Sep. 28, 2023 (JP) 2023-168864

(51) Int. Cl. B65H 43/04; B41J 29/00; B65H 29/62; B65H 31/24; G03G 15/00; G03G 21/02

(52) U.S. Cl. CPC B65H 43/04; B41J 29/00; B65H 29/62; B65H 31/24; G03G 15/50; G03G 15/6552; G03G 21/02; B65H 2801/06

(57) ABSTRACT

A printing apparatus comprising: a print unit configured to print print data on a sheet; an inspection execution unit configured to inspect the sheet printed by the print unit; and a control unit configured to switch, in a case where the inspection execution unit determines that the sheet is a defective sheet, a discharge destination of the defective sheet between a first discharge tray and a second discharge tray based on the number of sheets being conveyed and a predetermined number of allowable waste paper sheets.

### BACKGROUND OF THE INVENTION

### Field of the Invention

The present invention relates to a printing apparatus, a control method for the printing apparatus, and a non-transitory computer-readable storage medium.

### Description of the Related Art

A printed product output from a printing apparatus may have a stain arising from attachment of a color material of ink or toner to an unintended portion. Alternatively, a color loss in which color is lighter than original color may arise from a failure of attachment of a sufficient amount of color material to a portion where an image should be formed. A print failure such as a stain or color loss degrades the quality of the printed product. Therefore, the quality of a printed product is required to be guaranteed by inspecting the presence/absence of such print failures. Inspection is performed by, for example, calculating the presence/absence of a failure based on a difference between a reference image registered in advance and serving as the inspection standard of a printed product and an inspection target image obtained by scanning a printed product serving as an inspection target. If the calculated difference is larger than a threshold, the presence of a failure in the printed product is determined. Determining “the presence of a failure” in the printed product will be referred to as “inspection is NG” hereinafter. To the contrary, determining “the absence of a failure” will be referred to as “inspection is OK” hereinafter.

Japanese Patent Laid-Open No. 2022-99649 discloses a method of automatically changing the setting of an escape mode (a function for automatically executing reprinting of a printed product for which inspection is NG) in accordance with print job contents, more specifically, the number of documents. In a case where a defective sheet occurs in a job (to be referred to as a one-document job hereinafter) of printing a plurality of copies of one document, even if only a printed product for which inspection is NG is discharged to an error sheet discharge tray, the order of the printed products is kept. However, if the user selects an ON state of the escape mode, sheets fed after a defective sheet are also discharged to a discharge destination (error sheet discharge tray) different from that of normal sheets, and thus unnecessary waste paper occurs.

According to Japanese Patent Laid-Open No. 2022-99649, when a defective sheet is detected in a one-document job, it is possible to suppress occurrence of waste paper and the sheet replacement labor of the user to manually replace the printed product for which inspection is NG, by automatically setting the escape mode off.

However, in the technique described in Japanese Patent Laid-Open No. 2022-99649, the effect is limited to a one-document job, and if a defective sheet is detected in a job of printing a plurality of documents with different images, the user needs to accept the tradeoff relationship between the labor and waste paper.

### SUMMARY OF THE INVENTION

The present invention provides a technique for reducing the sheet replacement labor while suppressing occurrence of waste paper even for a print job of a plurality of documents.

According to one aspect of the present invention, there is provided a printing apparatus comprising: a print unit configured to print print data on a sheet; an inspection execution unit configured to inspect the sheet printed by the print unit; and a control unit configured to switch, in a case where the inspection execution unit determines that the sheet is a defective sheet, a discharge destination of the defective sheet between a first discharge tray and a second discharge tray based on the number of sheets being conveyed and a predetermined number of allowable waste paper sheets.

Further features of the present invention will become apparent from the following description of exemplary embodiments with reference to the attached drawings.

### BRIEF DESCRIPTION OF THE DRAWINGS

FIG. 1 is a view showing the overall arrangement of a printing apparatus according to an embodiment;

FIG. 2 is a functional block diagram of the printing apparatus according to the embodiment;

FIG. 3 is a functional block diagram of an inspection setting unit according to the embodiment;

FIG. 4 is a view showing an example of a user interface for accepting inspection settings according to the first embodiment;

FIG. 5 is a flowchart illustrating the procedure of processing of accepting the inspection settings according to the first embodiment;

FIG. 6 is a schematic view showing a state in which an inspection unit inspects a sheet image according to the embodiment;

FIGS. 7A and 7B are schematic views showing an outline of an operation and a discharge state when an escape mode is OFF;

FIGS. 8A to 8C are schematic views showing an outline of an operation and a discharge state when the escape mode is ON;

FIGS. 9A and 9B are a flowchart illustrating the procedure of processing in an automatic switching mode according to the first embodiment;

FIGS. 10A and 10B are a flowchart illustrating the procedure of processing of accepting inspection settings according to the second embodiment;

FIGS. 11A and 11B are tables respectively showing examples of conveyance path information and print setting information according to the second embodiment;

FIGS. 12A and 12B are tables showing a sheet price table and an ink price table according to the second embodiment;

FIG. 13 is a table showing a printing cost table according to the second embodiment; and

FIG. 14 is a view showing an example of a user interface for accepting the inspection settings according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

There is an escape mode as one function of an inspection system that inspects a failure (defect) of a printed product. The escape mode is a function of automatically executing reprinting of a printed product for which inspection is NG.

In a case where the escape mode is OFF, a printed product for which inspection is NG is discharged to the same sheet discharge tray as that of a printed product for which inspection is OK. Information (a page number and the like) of a printed product for which inspection is NG is stored in the inspection system, and displayed on a display of the inspection system, thereby notifying the user of it. In a case of printed products such as a book for which the order of the printed products discharged to the sheet discharge tray should be kept, a printed product for which inspection is NG is reprinted, and is manually replaced by the reprinted product.

On the other hand, in a case where the escape mode is ON, a printed product for which inspection is NG is discharged to an error sheet discharge tray different from a sheet discharge tray of a printed product for which inspection is OK, and reprinting is automatically executed from the printed product for which inspection is NG. In the case where the escape mode is ON, the order of the printed products discharged to the sheet discharged tray is kept. However, since the printed products are successively printed, sheets after the printed product for which it is determined that inspection is NG are already input to a sheet conveyance path, and are thus discharged to the error sheet discharge tray. This is done to keep the order of the printed products discharged to the sheet discharge tray, and the sheets after the printed product for which it is determined that inspection is NG are discharged to the error sheet discharge tray regardless of whether inspection is OK or NG. That is, in the case where the escape mode is ON, since the printed sheets after the printed product for which inspection is NG are discharged to the error sheet discharge tray and reprinted, the number of waste paper sheets is large.

In summary, according to the characteristics of the escape mode, in the case where the escape mode is OFF, it is possible to decrease the number of waste paper sheets in return for a manual operation. On the other hand, in the case where the escape mode is ON, automatic printing can be continued even if it is determined that inspection is NG, and thus the productivity increases but the number of waste paper sheets is large. The labor and waste paper have a tradeoff relationship for the user, and the user needs to accept one of the labor for manually replacing a printed product for which inspection is NG and waste paper occurring to ensure the printing order.

This embodiment will describe a method of automatically switching ON/OFF of the escape mode as one method of adjusting the tradeoff relationship between the sheet replacement labor required when the escape mode is OFF and waste paper occurring when the escape mode is ON.

More specifically, an example will be described, in which if, as a result of inspecting a printed sheet, it is determined that the sheet is a defective sheet, the discharge destination of the defective sheet is switched between a first discharge tray and a second discharge tray based on the number of sheets being conveyed and a predetermined number of allowable waste paper sheets.

### <Overall Arrangement of Printing Apparatus>

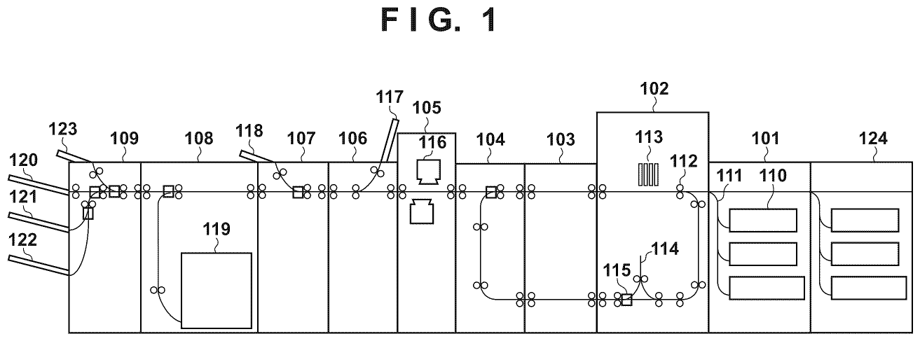

FIG. 1 is a view showing an example of the overall arrangement of a printing apparatus according to this embodiment. A print sheet flows from right to left in FIG. 1. Reference numeral 101 denotes a paper feed unit. The user fills a sheet input tray (sheet input port) 110 in the paper feed unit 101 with sheets before starting print processing. The paper feed unit 101 includes two trays in addition to the sheet input tray 110, and the user may fill these trays with sheets. A plurality of paper feed units 101 can be connected. In this example, a paper feed unit 124 has the same arrangement as that of the paper feed unit 101. Note that the paper feed units having the same shape are connected in this arrangement example but two or more different paper feed units may be connected.

After the start of the print processing, a sheet is taken from a tray designated by a print job, and conveyed by a conveyance path 111. Reference numeral 102 denotes a printing unit. A forward path (upper portion) of the conveyance path 111 includes a printhead 113 that prints a print sheet on the conveyance path. As the arrangement of the printhead 113, there is provided, for example, a method of directly discharging ink to a sheet or a method of transferring, to a sheet, toner adhered to a photosensitive member. However, this embodiment does not limit a printing method and a mode. A backward path (lower portion) of the conveyance path 111 includes a reversal mechanism 114 for reversing a print sheet.

Reference numeral 112 denotes a roller. A print belt is moved by rotating the rollers 112, thereby conveying a sheet. As shown in this arrangement view, there exist a plurality of rollers in each unit. Reference numeral 115 denotes a conveyance destination switching point, which includes a claw for switching the conveyance path. In this arrangement view, the conveyance destination switching point 115 is arranged in each of all portions where one conveyance path 111 branches into two paths. Reference numeral 103 denotes a fixing unit, which dries an adhered substance such as ink or toner printed on a print sheet, and fixes it to the print sheet by applying a pressure. Reference numeral 104 denotes a switching unit, which switches, when double-sided printing is designated, the conveyance path to the lower side to print a back surface after printing a front surface.

Reference numeral 105 denotes an inspection unit, which reads a conveyed printed product by a scanner 116, and performs inspection processing of comparing the read image with an inspection reference image. Reference numeral 106 denotes a sheet insertion unit, to which a sheet to be sandwiched between printed products is inserted from a sheet insertion port 117 at a timing designated by the user. Reference numeral 107 denotes a discharge unit, which switches whether to discharge a printed product to a discharge tray 118 or cause a printed product to flow to a subsequent unit. When generating a print job, the discharge tray 118 can be designated as the discharge destination of a printed product of the print job. Furthermore, the discharge tray 118 can be designated as an escape destination to which a printed product for which it is determined that the result of the inspection processing is NG is discharged.

Reference numeral 108 denotes a large-capacity discharge tray, which switches whether to discharge a printed product to a discharge tray 119 or cause a printed product to flow to a subsequent unit. The discharge tray 119 can hold a larger number of printed products than the discharge tray 118. Similar to the discharge tray 118, the discharge tray 119 can be designated not only as the discharge tray of a printed product but also as an escape tray. Reference numeral 109 denotes a multi-port discharge unit, which assigns printed products to discharge trays 120, 121, 122, and 123. Similar to the discharge tray 118, each of these discharge trays can be designated not only as the discharge tray of a printed product but also as an escape tray.

Each of the above-described units is added with a controller that controls each unit. The controller can include a CPU, a RAM, a storage device, and an external communication device, and can exchange information with another unit and perform calculation using the information.

### <Functional Arrangement>

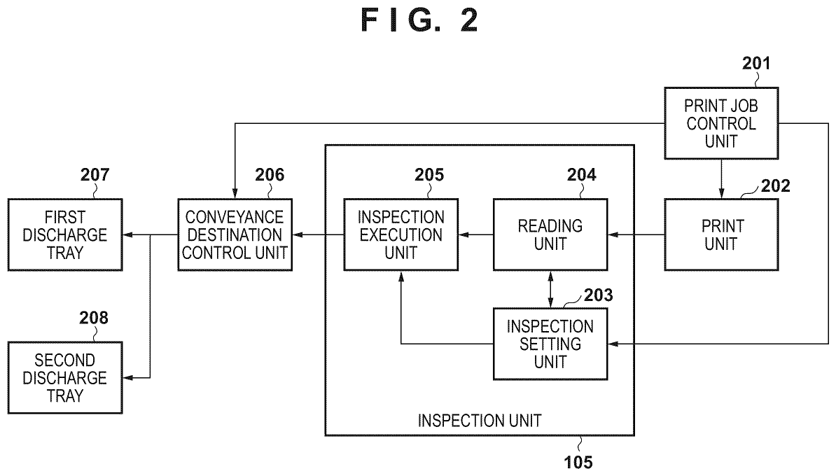

FIG. 2 shows the arrangement of the respective functional blocks of the printing apparatus according to this embodiment. Each functional block is implemented as a part of the controller that controls each unit, as shown in FIG. 1.

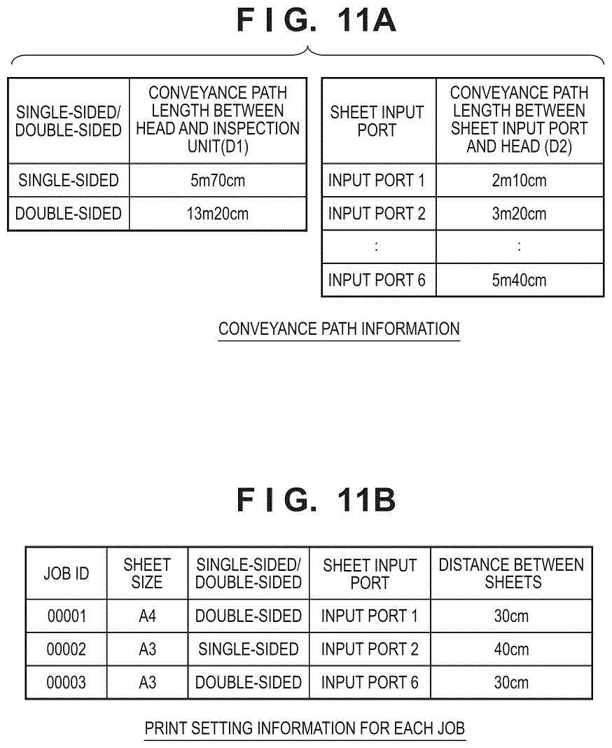

A print job control unit 201 accepts a print target file and print setting information corresponding to it from the user. In addition, the print job control unit 201 acquires conveyance path information held by each unit. The print setting information and the conveyance path information will be described later with reference to FIGS. 11A and 11B.

A print unit 202 receives a print job from the print job control unit 201, transmits print data to the printhead 113, and executes print processing at a timing when a sheet flows from the print belt. The print job indicates a print target file and print setting information corresponding to it, which have been accepted from the user.

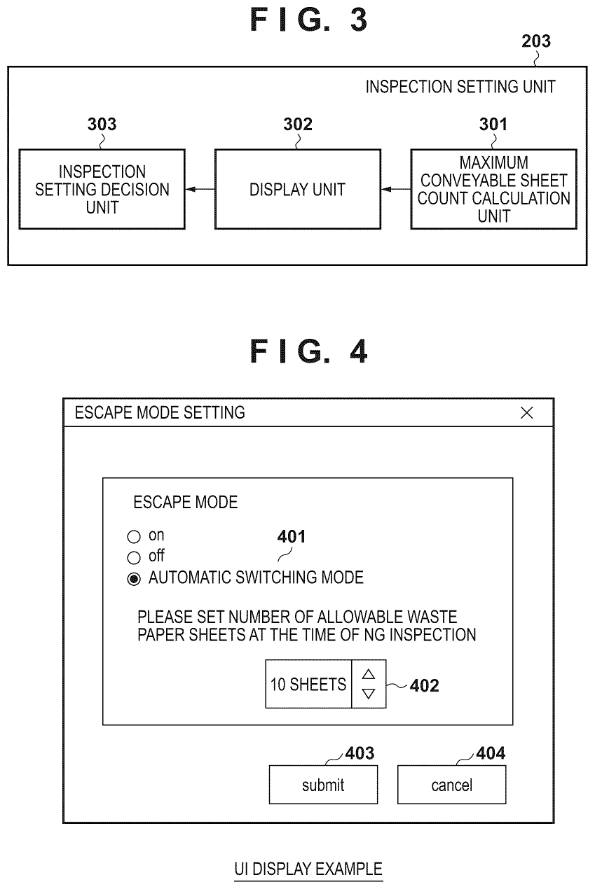

An inspection setting unit 203 accepts inspection settings for printed product inspection from the user. The inspection setting unit 203 will be described later with reference to FIG. 3. The inspection setting unit 203 accepts the print job and the conveyance path information from the print job control unit 201. A reading unit 204 reads the sheet by the scanner 116 at the timing when the sheet flows from the print belt, and transmits the read data as an inspection target image to an inspection execution unit 205. The inspection execution unit 205 acquires an inspection result by comparing the inspection target image received from the reading unit 204 with the inspection reference image held in advance based on the inspection settings accepted from the inspection setting unit 203.

The inspection reference image is electronic data that can be compared with the inspection target image on a pixel basis. A method of using, as the inspection reference image, RIP-processed electronic data of the print job received by the print job control unit 201, a method of using, as the inspection reference image, electronic data obtained by reading, by the reading unit 204, an image to be set as a reference by the user, and the like are considered. If the RIP-processed electronic data of the print job is used, the print job control unit 201 transmits the inspection reference image to the inspection setting unit 203 and the inspection execution unit 205 before the start of the print job. If the electronic data read by the reading unit 204 is used, the reading unit 204 transmits the inspection reference image to the inspection setting unit 203 and the inspection execution unit 205 before the start of the print job.

A conveyance destination control unit 206 receives the inspection result from the inspection execution unit 205, and controls the rollers 112 and the conveyance destination switching points 115 based on the print setting information managed by the print job control unit 201 with respect to a sheet on which the inspection target image is printed. This discharges the sheet to one of a first discharge tray 207 and a second discharge tray 208.

### <Detailed Arrangement of Inspection Setting Unit>

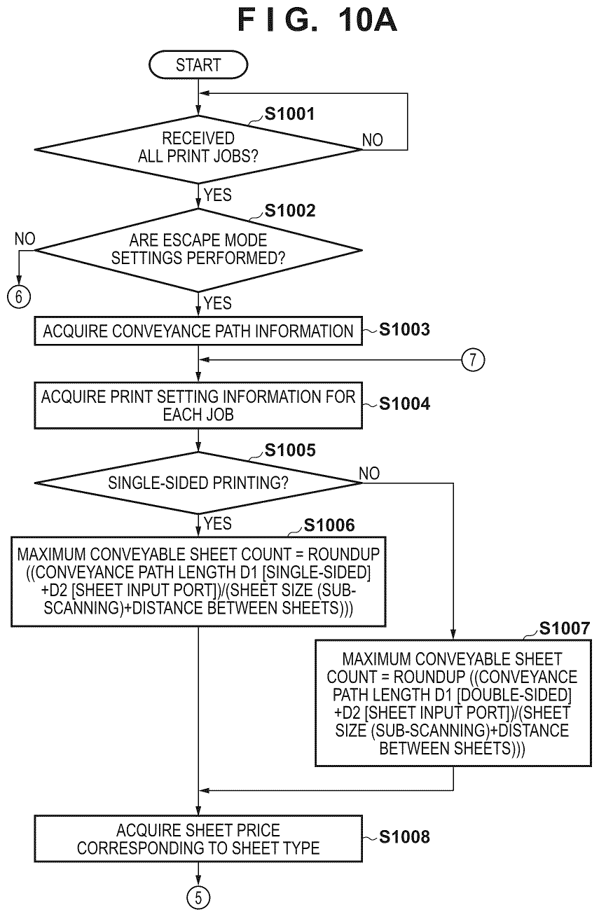

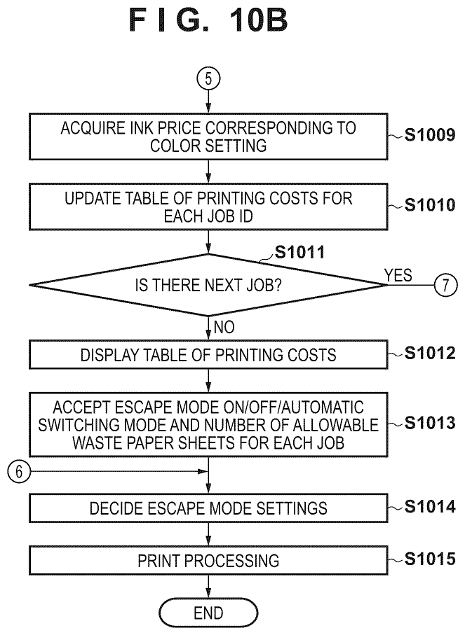

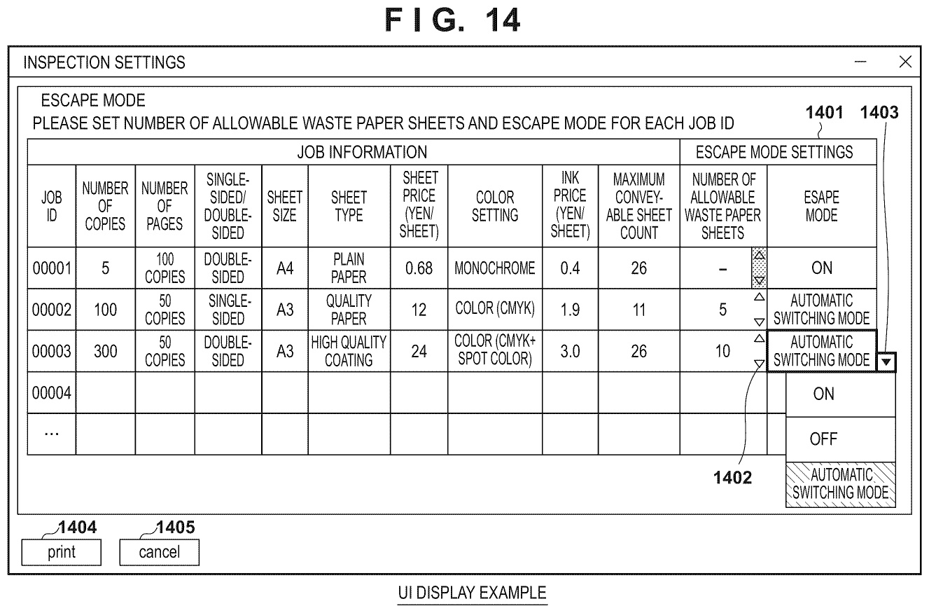

FIG. 3 is a block diagram showing the detailed arrangement of the respective functional blocks of the inspection setting unit 203 according to this embodiment. The inspection setting unit 203 includes a maximum conveyable sheet count calculation unit 301, a display unit 302, and an inspection setting decision unit 303. The maximum conveyable sheet count calculation unit 301 calculates the maximum conveyable sheet count from the conveyance path information and the print setting information. Details of the calculation method will be described later with reference to FIGS. 10A and 10B. The display unit 302 displays the user interface shown in FIG. 4 or 14, and accepts the inspection settings. The inspection setting decision unit 303 transmits, to the inspection execution unit 205, the inspection settings accepted from the user on the display unit 302.

### <User Interface>

FIG. 4 shows an example of the user interface for accepting the number of allowable waste paper sheets and the setting of the ON/OFF/automatic switching mode of the escape mode on the display unit 302 according to this embodiment. A setting portion 401 is a setting portion for setting the ON/OFF/automatic switching mode of the escape mode, and functions as a mode acceptance portion. A setting portion 402 is a setting portion for setting the number of allowable waste paper sheets accepted from the user, and functions as a sheet count acceptance portion.

The number of allowable waste paper sheets is used only when the automatic switching mode is applied in the setting portion 401. If the automatic switching mode is set, ON/OFF of the escape mode is automatically switched during printing in accordance with the number of allowable waste paper sheets and the number of sheets being conveyed. A button 403 is a button used to instruct to set the escape mode settings. A button 404 is a button used to clear all the escape mode settings.

The printing apparatus can operate in a first mode (escape mode OFF mode) of discharging, to the first discharge tray 207, a defective sheet, fed sheets subsequent to the defective sheet, and normal sheets for which the inspection execution unit 205 determines that there is no failure. The printing apparatus can operate in a second mode (escape mode ON mode) of discharging a defective sheet and fed sheets subsequent to the defective sheet to the second discharge tray 208, and discharging normal sheets to the first discharge tray 207. In addition, the printing apparatus can operate in a third mode (automatic switching mode) of automatically switching between the first mode and the second mode.

The third mode is a mode of automatically switching between the first mode and the second mode based on the number of sheets being conveyed and the predetermined number of allowable waste paper sheets when the inspection execution unit 205 determines that a sheet is a defective sheet.

### <Processing>

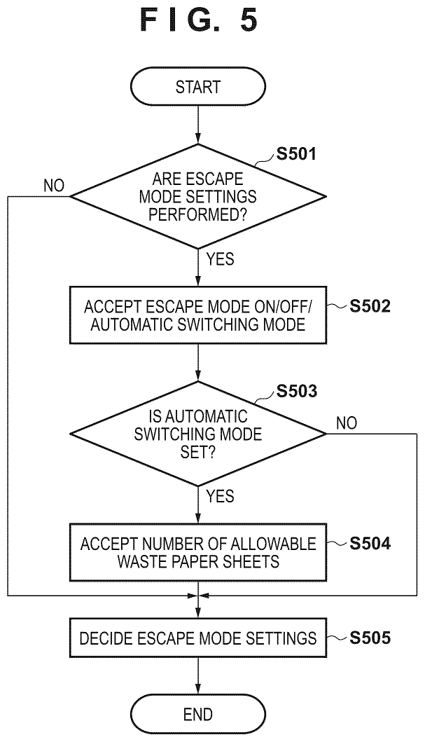

Subsequently, processing in which the user sets the ON/OFF/automatic switching mode of the escape mode will be described with reference to a flowchart shown in FIG. 5. In step S501, the inspection setting unit 203 determines whether the user makes the escape mode settings. For example, when the user opens the escape mode setting screen, it may be determined that the user makes the escape mode settings. If the user makes the escape mode settings (YES in step S501), the process advances to step S502. On the other hand, if the user does not make the escape mode settings (NO in step S501), the process advances to step S505.

In step S502, the inspection setting unit 203 accepts, via the setting portion 401 of the display unit 302, the escape mode settings set via the user interface shown in FIG. 4. In step S503, the inspection setting unit 203 determines whether the automatic switching mode has been set in step S502. If the automatic switching mode has been set (YES in step S503), the process advances to step S504. On the other hand, if the automatic switching mode has not been set (NO in step S503), the process advances to step S505.

In step S504, the inspection setting unit 203 accepts, via the setting portion 402 of the display unit 302, the number of allowable waste paper sheets input by the user. If the process advances from step S504, the inspection setting unit 203 decides, in step S505, the escape mode settings in response to the pressing of the button 403 of the display unit 302. Alternatively, if the setting other than the automatic switching mode has been set in step S502 (NO in step S503), the inspection setting unit 203 decides the escape mode settings in response to the pressing of the button 403 without accepting the number of allowable waste paper sheets. Then, if the user does not make the escape mode settings (NO in step S501), the inspection setting unit 203 decides the escape mode settings in a state in which the escape mode settings are initial values. Then, the series of processes shown in FIG. 5 ends.

### <Details of Inspection>

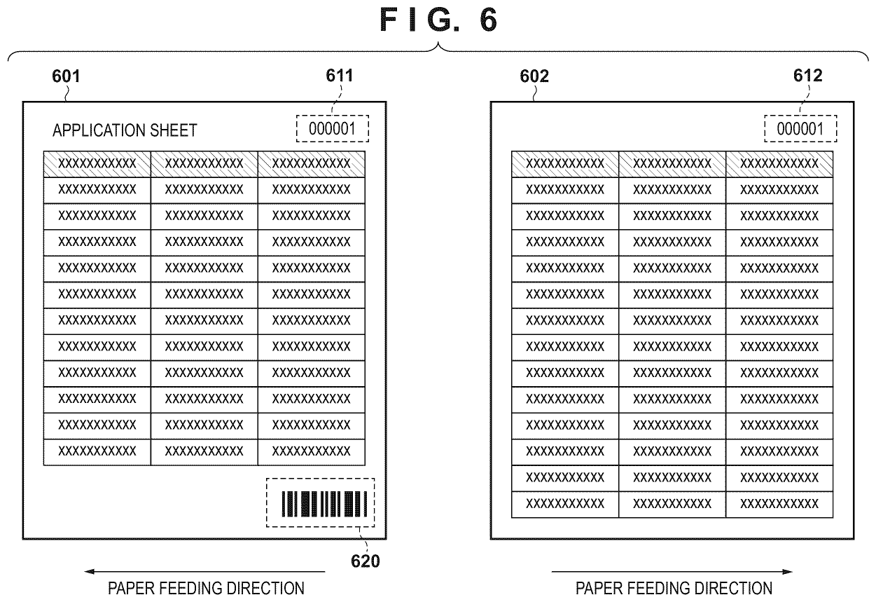

FIG. 6 is a schematic view showing a state in which the inspection unit 105 inspects a transmitted sheet image. An inspection area and inspection items can be set for the inspection unit 105 via the display unit 302. There are various inspection items. An example in which front and back verification inspection and barcode readability inspection are performed will now be described as an example.

Reference numeral 601 denotes a printed product obtained by reading the front surface of the sheet by the scanner 116; and 602, a sheet image obtained by reading the back surface of the sheet by the scanner 116. Reference numerals 611, 612, and 620 denote inspection areas as inspection targets. The inspection unit 105 extracts, as character data, a numerical value included in each of the inspection areas 611 and 612 by Optical Character Recognition (OCR). Assume here that the original data of a print job is configured so that the same numerical value is printed on each of the front and back surfaces of the sheet when printing is normally executed. This can determine whether the front and back surfaces of the sheet have been printed as intended. If the numerical values extracted from the inspection areas 611 and 612 are equal to each other, it is determined that printing is normally executed. If the numerical values are different from each other, it is determined that a failure is detected in printing.

Next, the inspection unit 105 determines whether a barcode existing in the inspection area 620 is readable. If the barcode is readable, it is determined that the barcode has normally been printed. If the barcode is unreadable, it is determined that a failure is detected in printing of the barcode. The inspection unit 105 performs these inspection operations. If it is determined in one of these inspection operations that a failure is detected in printing, it is determined that the sheet is an inspection NG sheet. If a failure is detected in neither of the inspection operations, it is determined that the sheet is an inspection OK sheet.

In addition, the inspection unit 105 can perform various inspection operations such as sheet printing position inspection, sheet duplicate inspection, sheet absence inspection, color misregistration inspection, and tint inspection but the present invention is not limited to these.

Next, an operation in a case where the inspection unit 105 determines that the sheet is an inspection NG sheet will be described. As an example, a case of a job for one copy including five pages will be described.

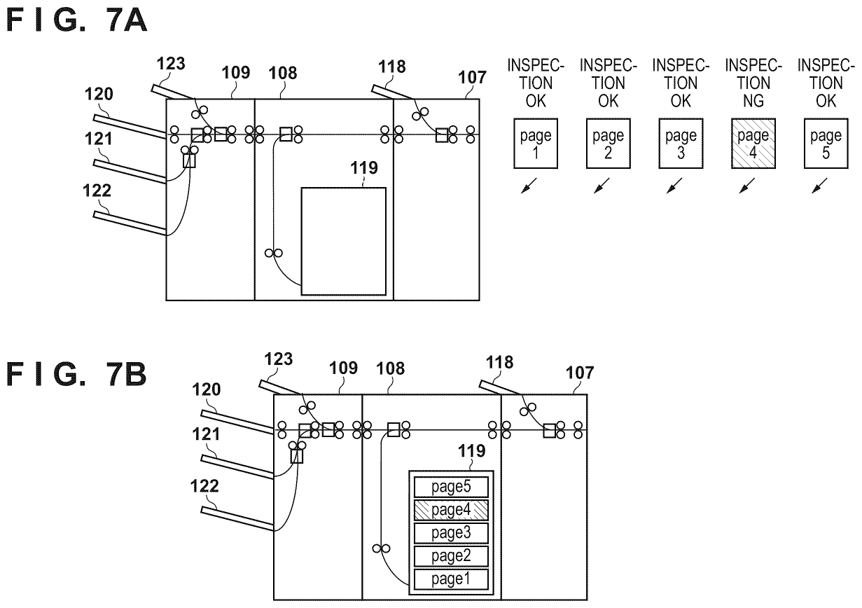

An operation when the escape mode is OFF will be described first with reference to FIGS. 7A and 7B. FIGS. 7A and 7B are views for explaining the discharge destination of a sheet when the escape mode is OFF. The setting of OFF of the escape mode is a setting of discharging, even if the inspection unit 105 determines that the sheet is an inspection NG sheet, the inspection NG sheet to the same discharge tray as that of an inspection OK sheet, and continuing printing. As shown in FIG. 7A, the inspection unit 105 performs image inspection for each sheet (each of first to fifth pages).

As shown in FIG. 7A, when the escape mode is OFF, the first to third and fifth sheets as inspection OK sheets, and the fourth sheet as an inspection NG sheet are all discharged to the first discharge tray 207. Finally, the first to fifth sheets are stacked on the first discharge tray 207, and the fourth sheet as an inspection NG sheet is mixed in a product on the first discharge tray 207.

Each arrow shown in FIG. 7A indicates a discharge direction of whether to discharge the sheet to the first discharge tray 207 (discharge tray 119) to which a sheet determined as a normal image by the inspection execution unit 205 is discharged or discharge the sheet to the second discharge tray 208 to which a sheet determined as an abnormal image by the inspection execution unit 205 is discharged. The first discharge tray 207 (discharge tray 119) is a discharge tray to which a normal sheet for which the inspection execution unit 205 determines that there is no failure is discharged. The example of the arrow shown in FIG. 7A indicates the discharge direction in which the sheet is discharged to the first discharge tray 207 (discharge tray 119), as shown in FIG. 7B.

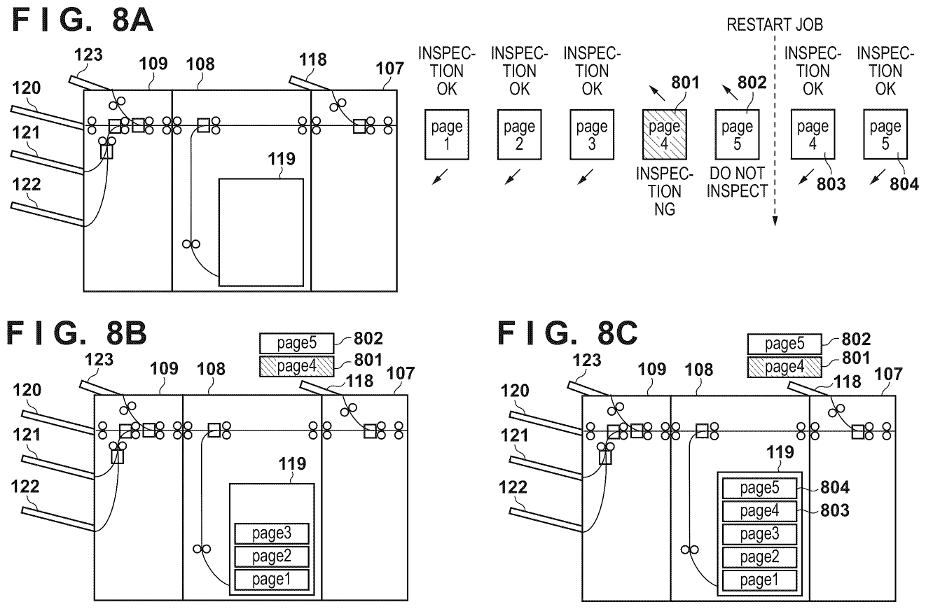

Next, an operation when the escape mode is ON will be described with reference to FIGS. 8A to 8C. FIGS. 8A, 8B, and 8C are views for explaining the discharge destination of each sheet when the escape mode is ON. The setting of ON of the escape mode is a setting of discharging, if the inspection unit 105 determines that the sheet is an inspection NG sheet, the inspection NG sheet and a subsequent fed sheet to a discharge tray different from that of an inspection OK sheet, and reprinting, on another sheet, an image printed on the inspection NG sheet.

As shown in FIG. 8A, when the escape mode is ON, the first to third sheets as inspection OK sheets are discharged to the first discharge tray 207 (discharge tray 119). On the other hand, a fourth sheet 801 as an inspection NG sheet is discharged to the second discharge tray 208 (discharge tray 118). Furthermore, a fifth sheet 802 as a sheet subsequent to the inspection NG sheet is discharged to the second discharge tray 208 (discharge tray 118), similar to the inspection NG sheet, without undergoing inspection by the inspection unit 105.

As a result, as shown in FIG. 8B, the first to third sheets as inspection OK sheets are discharged to the first discharge tray 207 (discharge tray 119), and the inspection NG sheet 801 and the sheet 802 subsequent to the inspection NG sheet are discharged to the second discharge tray 208 (discharge tray 118). After that, an image formed on the fourth sheet 801 as an inspection NG sheet is reprinted on a sixth sheet 803. In addition, an image formed on the fifth sheet 802 as the sheet subsequent to the inspection NG sheet is reprinted on a seventh sheet 804.

Then, the inspection unit 105 inspects the reprinted sixth sheet 803 and seventh sheet 804. If the reprinted sheets are inspection OK sheets, they are discharged to the first discharge tray 207 (discharge tray 119). Finally, as shown in FIG. 8C, a product in a state in which the first to fifth sheets have been printed is stacked on the first discharge tray 207 (discharge tray 119), and the inspection NG sheet 801 and the sheet 802 subsequent to the inspection NG sheet are stacked on the second discharge tray 208 (discharge tray 118).

Furthermore, when the escape mode is ON, the inspection unit 105 performs no inspection for the sheet 802 subsequent to the inspection NG sheet 801, and the subsequent sheet 802 is discharged to the second discharge tray 208 (discharge tray 118). Thus, the fourth sheet 801 and the fifth sheet 802 discharged to the second discharge tray 208 (discharge tray 118) are waste paper sheets but the page order of the product stacked on the first discharge tray 207 (discharge tray 119) is correct.

### <Processing in Automatic Switching Mode>

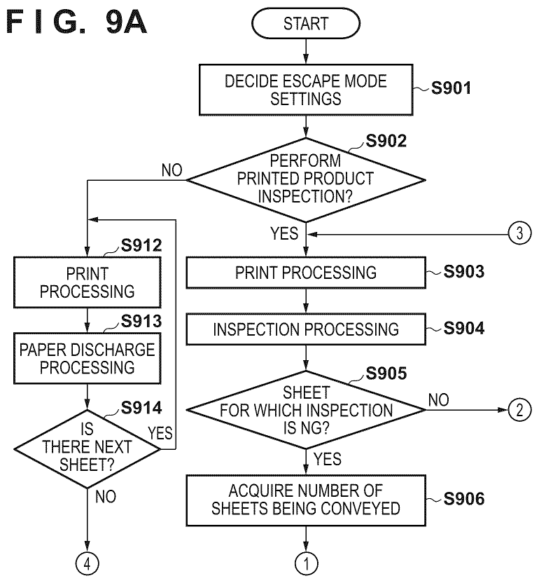

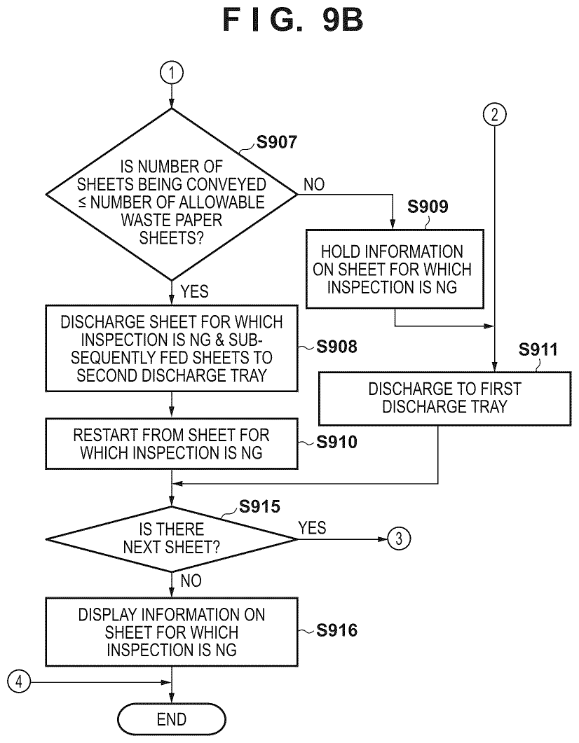

Processing in the automatic switching mode of switching the conveyance destination in accordance with the number of sheets being conveyed according to this embodiment will be described next with reference to a flowchart shown in FIGS. 9A and 9B. This description assumes a job for discharging a product to the first discharge tray 207.

In step S901, the inspection setting unit 203 accepts the decision of the escape mode settings from the user via the user interface shown in FIG. 4. In step S902, upon receiving a print job from the print job control unit 201, the inspection setting unit 203 determines whether to inspect a printed product. If a printed product is inspected with respect to the input job (YES in step S902), the process advances to step S903. On the other hand, if a printed product is not inspected with respect to the input print job (NO in step S902), the process advances to step S912.

In step S903, the print unit 202 executes actual print processing. In step S904, the inspection execution unit 205 performs image inspection processing for a sheet read by the reading unit 204. In step S905, the inspection execution unit 205 determines whether the sheet is an inspection NG sheet (that is, a defective sheet) as a result of the image inspection processing by the inspection unit 105. If the sheet is an inspection NG sheet (YES in step S905), the process advances to step S906. On the other hand, if the sheet is an inspection OK sheet (that is, a normal sheet) (NO in step S905), the process advances to step S906.

In step S906, the print job control unit 201 acquires the number of sheets being conveyed. The number of sheets being conveyed is the total number of sheets existing between the sheet input tray 110 and the inspection unit 105 in the printing apparatus and already printed when the sheet is determined as an inspection NG sheet. The number of sheets being conveyed can increase/decrease at the end of the job or during execution of maintenance.

In step S907, the conveyance destination control unit 206 determines whether the number of sheets being conveyed is equal to or smaller than the number of allowable waste paper sheets. If the number of sheets being conveyed is equal to or smaller than the number of allowable waste paper sheets (YES in step S907), the process advances to step S908. On the other hand, if the number of sheets being conveyed is larger than the number of allowable waste paper sheets (NO in step S907), the process advances to step S909.

In step S908, the conveyance destination control unit 206 discharges, to the second discharge tray 208 (discharge tray 118), the sheet determined as an inspection NG sheet and the fed sheets subsequent to the inspection NG sheet. That is, if the number of sheets being conveyed is equal to or smaller than the number of allowable waste paper sheets (YES in step S907), the conveyance destination control unit 206 switches, to the second discharge tray 208 (discharge tray 118), the discharge destination of the defective sheet and the fed sheets subsequent to the defective sheet. After all the fed sheets are discharged, printing is temporarily stopped.

In step S909, the conveyance destination control unit 206 holds information of the inspection NG sheet. In step S910, the print unit 202 restarts printing from the inspection NG sheet. That is, after the defective sheet and the fed sheet subsequent to the defective sheet are discharged to the second discharge tray 208 (discharge tray 118), the print unit 202 restarts printing from print data corresponding to the sheet determined as the defective sheet.

If the process advances from step S905, the conveyance destination control unit 206 discharges, in step S911, the sheet determined as the inspection OK sheet to the first discharge tray 207 (discharge tray 119). If the process advances from step S909, the conveyance destination control unit 206 discharges the sheet determined as the inspection NG sheet to the first discharge tray 207 (discharge tray 119). That is, if the number of sheets being conveyed is larger than the predetermined number of allowable waste paper sheets (NO in step S907), the conveyance destination control unit 206 switches the discharge destination of the defective sheet to the first discharge tray 207 (discharge tray 119).

In step S912, the print unit 202 executes print processing for the sheet. In step S913, the conveyance destination control unit 206 performs, for all the sheets, processing for discharging the sheet to the discharge tray. In step S914, the print unit 202 determines whether a next sheet exists. If a next sheet exists, the process returns to step S912. On the other hand, if no next sheet exists, the processing ends.

In step S915, the print unit 202 determines whether a next sheet exists. If a next sheet exists, the process returns to step S903, and the print processing and the inspection processing are repeated for the next sheet, and the above-described processing is performed for all the sheets of the job. On the other hand, if no next sheet exists, the process advances to step S916.

In step S916, with respect to the sheet that has been determined as the inspection NG sheet (YES in step S905) but discharged to the first discharge tray (NO in step S907), the inspection setting unit 203 presents the information of the inspection NG sheet held in step S909 to the user via the display unit 302 or the like at the end of the job. That is, display control of displaying the information of the defective sheet on the display unit 302 is performed. Based on the presented information, the user can discriminate the sheet that has been determined as the inspection NG sheet but discharged to the first discharge tray 207 (discharge tray 119).

As described above, according to this embodiment, control is executed to switch the conveyance destination of the sheet when an inspection NG sheet is generated, based on the number of allowable waste paper sheets and the number of sheets being conveyed. That is, whether to use the automatic reprinting function is automatically switched using the number of sheets being conveyed and the number of allowable waste paper sheets.

This can suppress the labor for replacing an inspection NG sheet while suppressing occurrence of waste paper. As described above, according to this embodiment, even for a print job for a plurality of documents, it is possible to reduce the sheet replacement labor while suppressing occurrence of waste paper.

### Second Embodiment

This embodiment will describe an example in which auxiliary information for setting the number of allowable waste paper sheets is presented to the user at the time of escape mode setting and the user optimizes, for each job, the number of allowable waste paper sheets and the setting of the ON/OFF/automatic switching mode of the escape mode. The auxiliary information includes at least one of the number of pages included in each job, the number of copies, single-sided/double-sided, a sheet size, a sheet type, a sheet price corresponding to the sheet type, a color setting, an ink price corresponding to the color setting, the maximum conveyable sheet count, and the like. These pieces of information are displayed on a user interface.

A system configuration, functional blocks, and a user interface are almost the same as in the first embodiment. Different points from the first embodiment concern the interface shown in FIG. 4 and the flowchart shown in FIG. 5, and will be described with reference to an interface shown in FIG. 14 and a flowchart shown in FIGS. 10A and 10B.

### <User Interface>

FIGS. 10A and 10B are a flowchart illustrating the procedure of processing in which auxiliary information for setting the escape mode and the number of allowable waste paper sheets at the time of escape mode setting in an inspection setting unit 203 according to this embodiment is presented to the user and the user optimizes the number of allowable waste paper sheets for each job.

In step S1001, a print job control unit 201 stands by for receiving a print job, and determines whether all print jobs have been received. If all the print jobs have been received, the process advances to step S1002. On the other hand, if not all the print jobs have been received, the print job control unit 201 stands by.

In step S1002, the inspection setting unit 203 determines whether the user makes escape mode settings. For example, if the user opens an escape mode setting screen, it may be determined that the user makes the escape mode settings.

If the user makes the escape mode settings (YES in step S1002), the process advances to step S1003. On the other hand, if the user does not make the escape mode settings (NO in step S1002), the process advances to step S1014.

In step S1003, a maximum conveyable sheet count calculation unit 301 acquires conveyance path information from the print job control unit 201. The conveyance path information is information shown in FIG. 11A, and is information representing a path through which a sheet is conveyed at the time of printing. The conveyance path information includes a conveyance path length D1 (there are a value for single-sided printing and a value for double-sided printing) from a printhead 113 to an inspection unit 105. The conveyance path information includes a conveyance path length D2 from each of sheet input trays 110 and 124 to the printhead 113.

In step S1004, the maximum conveyable sheet count calculation unit 301 acquires print setting information for each job from the first one of the received job IDs. The print setting information is information managed by the print job control unit 201, and is information shown in FIG. 11B. The print setting information includes the print settings of a single job or a plurality of jobs. The print settings of one job include data concerning at least one of a job ID, a sheet size, single-sided/double-sided, a sheet input port, and a distance between sheets. The distance between the sheets is a value decided based on the specifications (a print speed and the like) of a printing unit 102 and the sheet size, and is data that holds in advance a value for each sheet size by the print job control unit 201.

In step S1005, the maximum conveyable sheet count calculation unit 301 determines whether single-sided printing is executed. If single-sided printing is executed (YES in step S1005), the process advances to step S1006. On the other hand, if no single-sided printing is executed (NO in step S1005), the process advances to step S1007.

In step S1006, the maximum conveyable sheet count calculation unit 301 decides the maximum conveyable sheet count based on a formula of ROUNDUP((conveyance path D1 [single-sided]+conveyance path length D2 [sheet input port])/(sheet size (conveyance direction)+distance between sheets)). If there is a fractional part, one subsequent sheet is also influenced and discharged as a waste paper sheet, and thus the ROUNDUP function is used, that is, the fractional part is rounded up, thereby deciding the maximum conveyable sheet count.

In step S1007, the maximum conveyable sheet count calculation unit 301 decides the maximum conveyable sheet count based on a formula of ROUNDUP((conveyance path D1 [double-sided]+conveyance path length D2 [sheet input port])/(sheet size (conveyance direction)+distance between sheets)). If there is a fractional part, one subsequent sheet is also influenced and discharged as a waste paper sheet, and thus the ROUNDUP function is used, that is, the fractional part is rounded up, thereby deciding the maximum conveyable sheet count.

In the case of the conveyance path information shown in FIG. 11A and the print setting information shown in FIG. 11B, the maximum conveyable sheet count is calculated, as follows. If the job ID is 00001, the maximum conveyable sheet count is obtained by ROUNDUP((1320 cm+210 cm)/(29.7 cm (A4 portrait)+30 cm))=26. By performing calculation using the same calculation formula, the maximum conveyable sheet count for a job ID of 00002 is 11, and the maximum conveyable sheet count for a job ID of 00003 is 26.

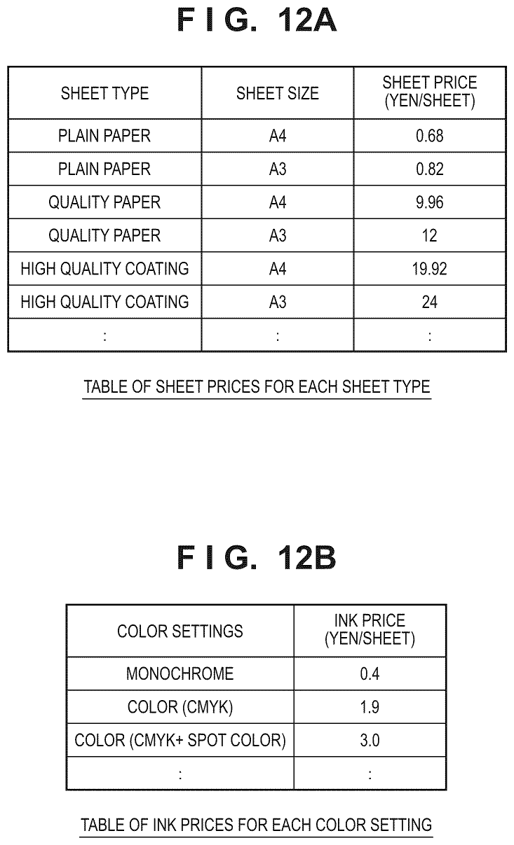

In step S1008, the inspection setting unit 203 acquires a sheet price for each sheet type based on the sheet size and sheet type information included in the acquired print setting information. The sheet price for each sheet type is, for example, information shown in FIG. 12A, and includes sheet price data corresponding to a combination of the sheet type and the sheet size.

In step S1009, the inspection setting unit 203 acquires an ink price for each color setting based on color setting information included in the acquired print setting information. The ink price for each color setting is, for example, information shown in FIG. 12B, and includes ink price data corresponding to the color setting.

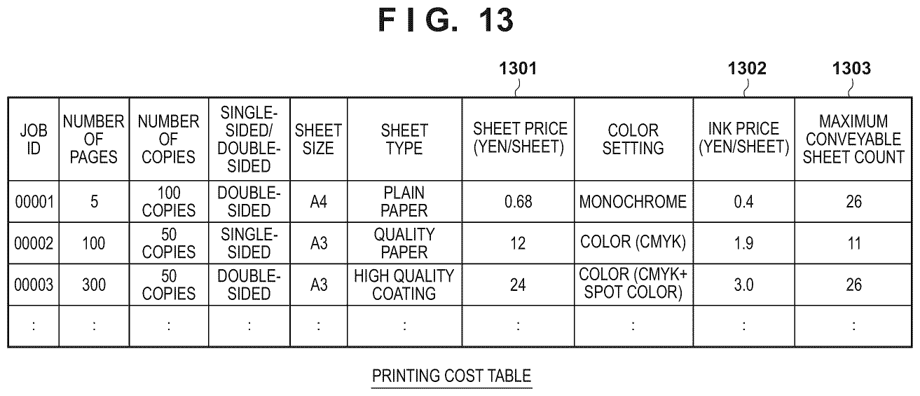

In step S1010, the inspection setting unit 203 generates or updates, for each job ID, a printing cost table including information of a cost needed for printing, as shown in FIG. 13. The sheet price, ink price, and maximum conveyable sheet count acquired in the above steps are reflected in columns 1301, 1302, and 1303 in FIG. 13, respectively.

In step S1011, the print job control unit 201 determines whether a next print job exists. If a next print job exists (YES in step S1011), the process returns to step S1004, and the printing cost table update processing is repeated for the next print job, and the above-described processing is performed for all the print jobs. On the other hand, if no next print job exists (NO in step S1011), that is, the processing is complete for all the print jobs, the process advances to step S1012.

In step S1012, the inspection setting unit 203 displays the generated printing cost table on a display unit 302. In step S1013, the inspection setting unit 203 accepts the escape mode setting and the number of allowable waste paper sheets from the user interface shown in FIG. 14 to be described later.

In step S1014, the inspection setting unit 203 decides the escape mode settings based on the acceptance result in step S1013. Note that if the user does not make the escape mode settings (NO in step S1002), the inspection setting unit 203 decides a state in which the escape mode settings are initial values. In step S1015, the print unit 202 starts print processing under the decided escape mode settings.

FIG. 14 shows an example of the user interface for accepting the number of allowable waste paper sheets and the ON/OFF/automatic switching mode of the escape mode from the user via the printing cost table displayed on the display unit 302 in the processing of the flowchart shown in FIGS. 10A and 10B.

A table 1401 indicates a table display portion for displaying the printing cost table in the flowchart shown in FIGS. 10A and 10B. A setting portion 1402 accepts the number of allowable waste paper sheets for each job ID from the user. The number of allowable waste paper sheets is used only when the automatic switching mode is applied. A setting portion 1403 accepts the ON/OFF/automatic switching mode of the escape mode for each job ID from the user.

If the automatic switching mode is set, ON/OFF of the escape mode is automatically switched during printing in accordance with the number of allowable waste paper sheets set in the setting portion 1402 and the number of sheets being conveyed. A button 1404 is a button used to instruct the escape mode settings. A button 1405 is a button used to clear all the escape mode settings.

As described above, according to this embodiment, even if the user has difficulty in selecting the input value of the number of allowable waste paper sheets and the escape mode, the user can optimize, for each job, the number of allowable waste paper sheets and the setting of the ON/OFF/automatic switching mode of the escape mode.

### Other Examples

The number of sheets being conveyed changes in accordance with whether printing or maintenance is in progress, whether double-sided printing or single-sided printing is executed, or the like. For example, if double-sided printing is currently executed, the number of sheets being conveyed is, for example, 30. This is because the sheet is conveyed to the lower portion such as the reversal mechanism 114 or the conveyance destination switching point 115 shown in FIG. 1 and thus the number of sheets being conveyed is large. If single-sided printing is currently executed, the number of sheets being conveyed is, for example, 12. This is because the sheet is not conveyed to the lower portion such as the reversal mechanism 114 or the conveyance destination switching point 115 shown in FIG. 1 and thus the number of sheets being conveyed is small. During maintenance or at the end of the print job, the number of sheets being conveyed is small (for example, three to five).

Assume here that, for example, the number of allowable waste paper sheets is six. In this case, during double-sided printing, since the number of sheets being conveyed which is 30 is larger than the number of allowable waste paper sheets which is 6, the escape mode is automatically switched to OFF to reduce waste paper, and a sheet is discharged to the normal discharge tray (for example, the discharge tray 119). Similarly, during single-sided printing, since the number of sheets being conveyed which is 12 is larger than the number of allowable waste paper sheets which is 6, the escape mode is automatically switched to OFF to reduce waste paper, and a sheet is discharged to the normal discharge tray (for example, the discharge tray 119). During maintenance or at the end of the print job, since the number of sheets being conveyed which is three to five is smaller than the number of allowable waste paper sheets which is 6, the escape mode is automatically switched to ON to allow waste paper and reduce the sheet replacement labor. Then, a sheet is discharged to a discharge tray for escape (for example, the discharge tray 118).

Note that the present invention is not limited to the example in which the user inputs and decide the number of allowable waste paper sheets, and it may be configured to select a predetermined numerical value in accordance with the sheet price and/or the ink price. For example, if the sheet price shown in FIG. 12A is equal to or higher than a predetermined price, a first numerical value (for example, five) may be decided as the number of allowable waste paper sheets, and if the sheet price is lower than the predetermined price, a second numerical value (for example, 10) larger than the first numerical value may be decided as the number of allowable waste paper sheets. Alternatively, if the ink price shown in FIG. 12B is equal to or higher than a predetermined price, the first numerical value (for example, five) may be decided as the number of allowable waste paper sheets, and if the ink price is lower than the predetermined price, the second numerical value (for example, 10) larger than the first numerical value may be decided as the number of allowable waste paper sheets. Alternatively, table information that defines, in advance, the number of allowable waste paper sheets corresponding to a combination of each sheet price and each ink price may be held and the number of allowable waste paper sheets may be decided based on the table information. Note that the automatically decided number of allowable waste paper sheets may be presented to the user and the input of a change may directly be accepted from the user.

According to the present invention, even for a print job for a plurality of documents, it is possible to reduce the sheet replacement labor while suppressing occurrence of waste paper.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168864, filed Sep. 28, 2023, which is hereby incorporated by reference herein in its entirety.

What is claimed is:

1. A printing apparatus comprising:
a print unit configured to print print data on a sheet;
an inspection execution unit configured to inspect the sheet printed by the print unit; and
a control unit configured to switch, in a case where the inspection execution unit determines that the sheet is a defective sheet, a discharge destination of the defective sheet between a first discharge tray and a second discharge tray based on the number of sheets being conveyed and a predetermined number of allowable waste paper sheets.

2. The apparatus according to claim 1, wherein in a case where the number of sheets being conveyed is larger than the predetermined number of allowable waste paper sheets, the control unit switches the discharge destination of the defective sheet to the first discharge tray.

3. The apparatus according to claim 2, wherein the first discharge tray is a discharge tray to which a normal sheet for which the inspection execution unit determines that there is no failure is discharged.

4. The apparatus according to claim 1, wherein in a case where the number of sheets being conveyed is not larger than the predetermined number of allowable waste paper sheets, the control unit switches the discharge destination of the defective sheet to the second discharge tray.

5. The apparatus according to claim 4, wherein in a case where the number of sheets being conveyed is not larger than the predetermined number of allowable waste paper sheets, the control unit switches a discharge destination of the defective sheet and a fed sheet subsequent to the defective sheet to the second discharge tray.

6. The apparatus according to claim 5, wherein after the defective sheet and the fed sheet are discharged to the second discharge tray, the print unit restarts printing from print data corresponding to the sheet determined as the defective sheet.

7. The apparatus according to claim 1, wherein the printing apparatus is operable in one of
a first mode of discharging, to the first discharge tray, the defective sheet, a fed sheet subsequent to the defective sheet, and a normal sheet for which the inspection execution unit determines that there is no failure,
a second mode of discharging the defective sheet and the fed sheet to the second discharge tray and discharging the normal sheet to the first discharge tray, and
a third mode of automatically switching between the first mode and the second mode.

8. The apparatus according to claim 7, wherein the third mode is a mode of automatically switching between the first mode and the second mode based on the number of sheets being conveyed and the predetermined number of allowable waste paper sheets in a case where the inspection execution unit determines that the sheet is the defective sheet.

9. The apparatus according to claim 7, further comprising a mode acceptance unit configured to accept selection of one of the first mode, the second mode, and the third mode.

10. The apparatus according to claim 1, further comprising a sheet count acceptance unit configured to accept a setting of the predetermined number of allowable waste paper sheets.

11. The apparatus according to claim 1, further comprising a display control unit configured to display information of the defective sheet on a display unit.

12. The apparatus according to claim 1, further comprising:
a conveyance path information acquisition unit configured to acquire conveyance path information representing a path through which a sheet is conveyed at the time of printing; and
a print setting information acquisition unit configured to acquire print setting information.

13. The apparatus according to claim 12, further comprising a generation unit configured to generate, for each print job, based on the conveyance path information and the print setting information, a printing cost table including information of a cost needed for printing.

14. The apparatus according to claim 12, wherein the print setting information includes data concerning at least one of a print job ID, a sheet size, single-sided/double-sided, a sheet input port, and a distance between sheets.

15. The apparatus according to claim 1, wherein the number of sheets being conveyed is the total number of sheets existing between a sheet input tray in the printing apparatus and an inspection unit including the inspection execution unit and already printed when the sheet is determined as the defective sheet.

16. A control method for a printing apparatus, comprising:
printing print data on a sheet;
inspecting the sheet printed in the printing; and
switching, in a case where it is determined in the inspecting that the sheet is a defective sheet, a discharge destination of the defective sheet between a first discharge tray and a second discharge tray based on the number of sheets being conveyed and a predetermined number of allowable waste paper sheets.

17. A non-transitory computer-readable storage medium storing a program for causing a computer to execute a control method for a printing apparatus, the method comprising:
printing print data on a sheet;
inspecting the sheet printed in the printing; and
switching, in a case where it is determined in the inspecting that the sheet is a defective sheet, a discharge destination of the defective sheet between a first discharge tray and a second discharge tray based on the number of sheets being conveyed and a predetermined number of allowable waste paper sheets.
